(19) United States
(12) Patent Application Publication
(10) Pub. No.: US 2018/0152543 A1
(43) Pub. Date: May 31, 2018

(54) EMERGENCY DATA CUTOFF FOR STORAGE SYSTEMS

(71) Applicant: INTERNATIONAL BUSINESS MACHINES CORPORATION, Armonk, NY (US)

(72) Inventors: David Monczynski, San Jose, CA (US); Alexandru Z. Nagy, Gilroy, CA (US); Kaoru Stabnow, Colorado Springs, CO (US)

(21) Appl. No.: 15/362,844

(22) Filed: Nov. 29, 2016

(51) Int. Cl. H04L 29/06; H04L 29/08

(52) U.S. Cl. CPC H04L 67/40; H04L 67/1097; H04L 67/24

(57) ABSTRACT

A computer system includes a network switch coupled to a network, a remote cutoff device coupled to the network switch, and a security alert system connected to the network and coupled to the remote cutoff device. The security alert system receives input from the network indicating data that may be harmful to the system and communicates an alert to the remote cutoff device. The remote cutoff device transmits a cutoff signal to the network switch, which causes data flow into or out of the network switch to be immediately interrupted.

### BACKGROUND

The present invention relates generally to data storage systems, and more particularly to data storage system security.

In a data storage system, one way to prevent potentially harmful data from being transmitted is to power down the controlling storage server by initiating a prescribed shut-down procedure. However, before such a procedure can complete, harmful data may still be transmitted. Another possibility is to instantly cut off power to the server (assuming that a backup power unit is not automatically activated). However, shutting down data storage by instantly turning off power to a storage server, rather than performing a prescribed shut-down procedure is problematic. For one thing, it may be time consuming to subsequently restart the server. In some cases, qualified personnel may be needed to bring the server back online. And in extreme cases, incorrectly shutting down the server may result in damage to the hardware.

Therefore, it would be advantageous to method to safely and quickly prevent transmittal of potentially harmful data in a data storage system.

### SUMMARY

In an aspect of the invention, a computer system includes a network switch coupled to a network, a remote cutoff device coupled to the network switch, and a security alert system connected to the network and coupled to the remote cutoff device. The security alert system receives input from the network indicating data that may be harmful to the system and communicates an alert to the remote cutoff device. The remote cutoff device transmits a cutoff signal to the network switch, which causes data flow into or out of the network switch to be immediately interrupted.

In another aspect of the invention, a computer system includes a storage server connected to a first network via a first network switch and connected to a second network via a second network switch, a remote cutoff device coupled to the first network switch and the second network switch, and a security alert system connected to the first network and the second network and coupled to the remote cutoff device. The security alert system receives input from the first network and the second network indicating data that may be harmful to the system and communicate an alert to the remote cutoff device. The remote cutoff device transmits a cutoff signal to the first network switch and/or the second network switch, which causes data flow into or out of the storage server to be immediately interrupted.

### BRIEF DESCRIPTION OF THE DRAWINGS

FIG. 1 is a schematic diagram depicting various components of a computing environment, in accordance with an embodiment of the present invention.

FIG. 2 is another schematic diagram depicting various components of a computing environment, in accordance with an embodiment of the present invention.

FIG. 3 is a flowchart depicting various operational steps in interrupting data flow, in accordance with an embodiment of the present invention.

FIG. 4 is a functional block diagram illustrating a data processing environment, in accordance with an embodiment of the present invention.

FIG. 5 depicts a cloud computing environment according to an embodiment of the present invention.

FIG. 6 depicts abstraction model layers according to an embodiment of the present invention.

### DETAILED DESCRIPTION

Embodiments of the present invention are directed to computer systems for causing data flow in a storage system to be immediately interrupted in case potentially harmful data is detected.

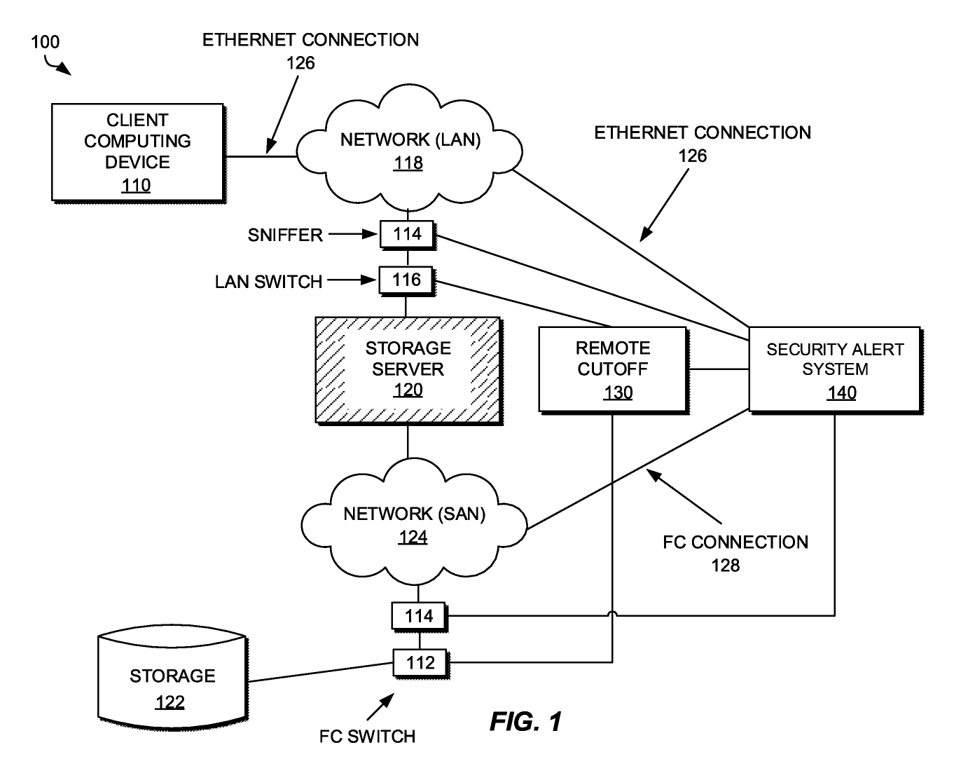

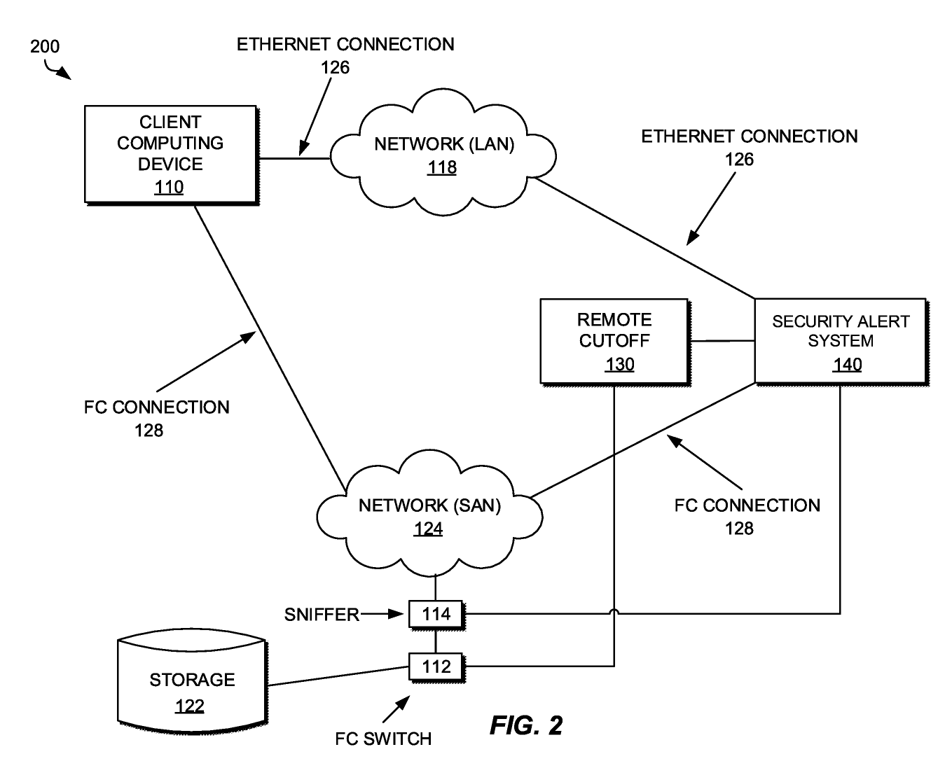

FIGS. 1 and 2 are schematic diagrams of computing environments in which embodiments of the present invention may be practiced. Those skilled in the art will appreciate that the computing environments depicted are merely for the purpose of illustration and that embodiments of the invention may also find useful application in other computing environments, for example, in computing environments that combine components of FIGS. 1 and 2.

FIG. 1 is a schematic diagram of a computing environment 100, in accordance with an embodiment of the present invention. Computing environment 100 includes client computing device 110 connected over network 118 via a network switch such as LAN switch 116 to a storage server 120. Storage server 120 is connected over storage area network (SAN) 124 via a network switch such as FC switch 112 to a storage device 122. Security alert system 140 is connected to remote cutoff 130, to SAN 124 via a Fibre Channel (FC) connection 128, and to network 118 via an Ethernet connection 126. In various embodiments of the invention, remote cutoff 130 is connected to LAN switch 116 and/or to FC switch 112.

Computing environment 100 may include one or more storage devices 122. Storage devices 122 may be, for example, solid-state drives (SSD), hard disk drives (HDD), tape units, or cloud storage devices. In an embodiment of the invention, computing environment 100 may include a sniffer 114 between storage server 120 and network 118, and/or between storage device 122 and SAN 124. Sniffers 114 may be connected to security alert system 140.

Network 118 can be, for example, a local area network (LAN), a wide area network (WAN) such as the Internet, or a combination of the two, and can include wired, wireless, or fiber optic connections. In general, network 118 can be any combination of connections and protocols that will support communications between client computing device 110 and storage servers 120, and between various devices (not shown) attached to network 118 and security alert system 140, in accordance with embodiments of the present invention.

Storage server 120 can be any server that is used to store, access, secure, and manage data on storage devices such as storage device 122, in accordance with an embodiment of the invention. Storage servers are generally designed for storing and accessing varying amounts of data over a shared network, such as the internet, a WAN, a LAN, or a SAN. A typical computing environment may include one or more storage servers 120 connected to one or more storage devices 122 via network 118 and/or SAN 124.

SAN 124 is a specialized, high-speed network that provides block-level network access to data storage such as storage devices 122, in accordance with an embodiment of the invention. SANs typically connect servers such as storage servers 120, network switches such as FC switch 112, and storage devices 122, using various technologies, topologies, and protocols. SANs may also span multiple sites. SANs are primarily used to enhance storage devices 122, such as disk arrays and tape libraries, making them accessible to storage servers 120 so that the storage devices appear to computing devices such as client computing device 110 as if they were attached locally. SAN 124 typically has its own network of storage devices 122 that are generally not directly accessible through network 118 by other devices connected to network 118.

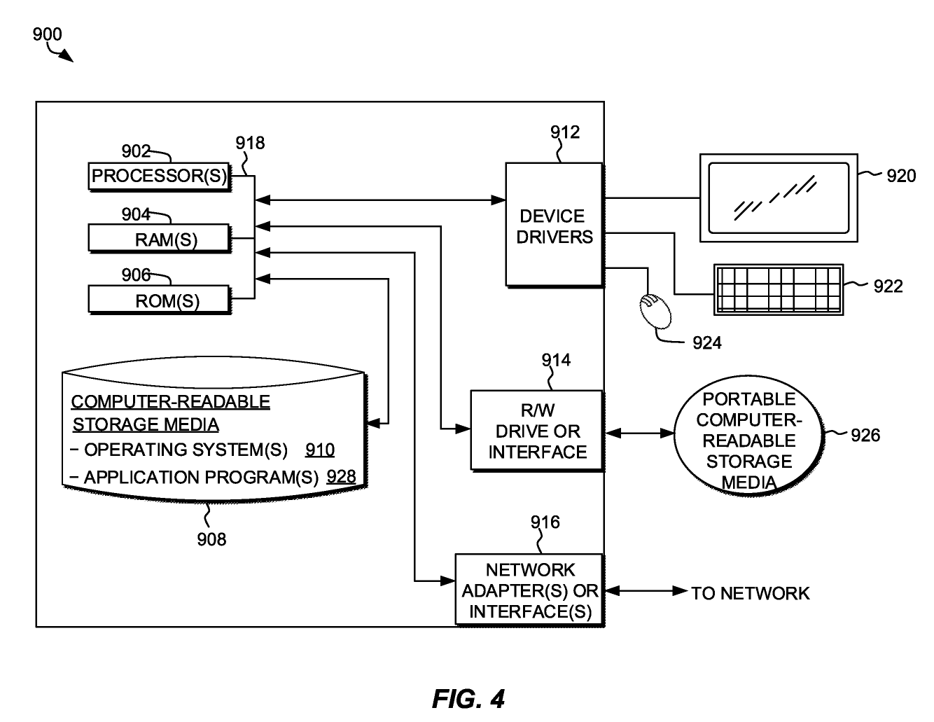

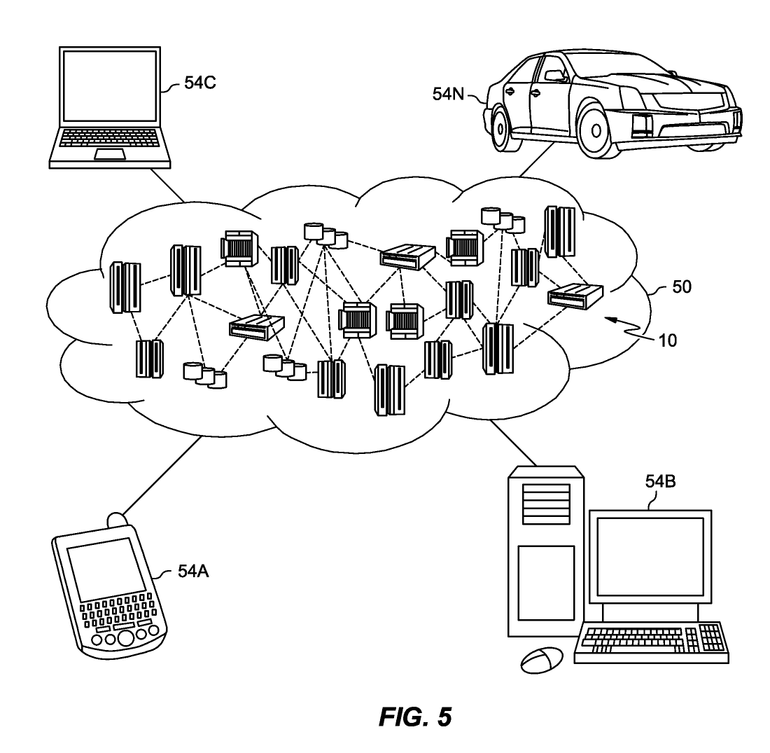

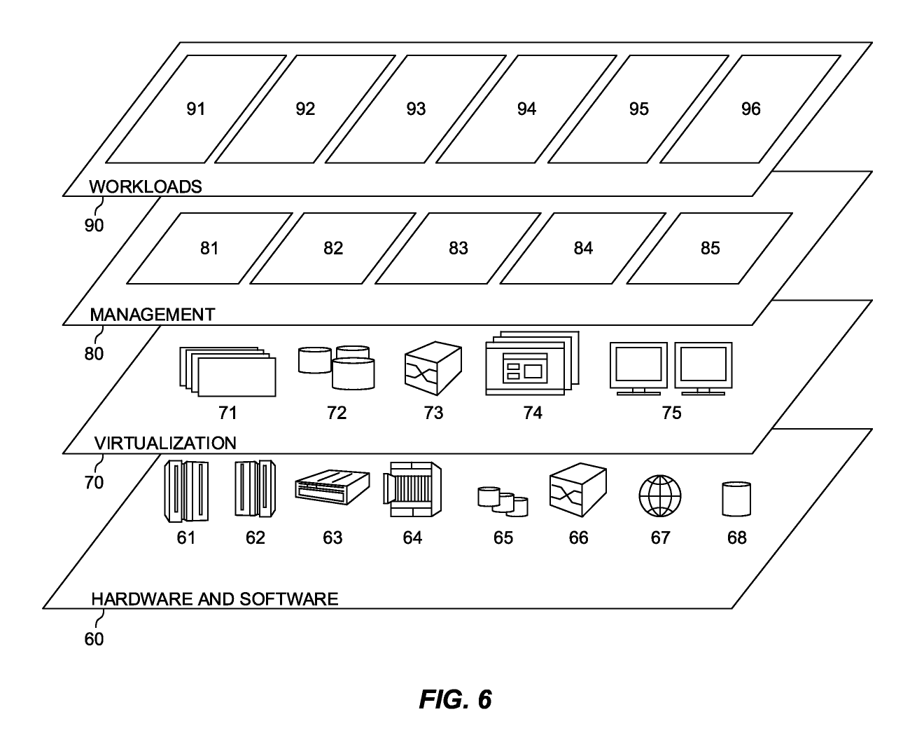

Client computing device 110 represents a computing platform that accesses storage devices 122. In various embodiments of the invention, client computing device 110 may be, for example, a laptop computer, tablet computer, netbook computer, personal computer (PC), a desktop computer, a personal digital assistant (PDA), or a smart phone. In general, a client computing device 110 may be any programmable electronic device capable of accessing storage device 122 via network 118 or via SAN 124, and of supporting functionality as required by one or more embodiments of the invention. Client computing device 110 may include internal and external hardware components as depicted and described in further detail below with reference to FIG. 4, below. In other embodiments, client computing device 110 may be implemented in a cloud computing environment, as described in relation to FIGS. 5 and 6, below. Computing environment 100 may include one or more client computing devices 110.

Security alert system 140 operates generally to detect or be notified of an emergency situation and send an alert to a remote cutoff 130, in accordance with an embodiment of the invention. An emergency situation may involve data that is potentially harmful to the system. In an embodiment of the present invention, the emergency situation may be an exploit that involves data entering or exiting a storage device or a storage server, such as an attempt to transmit a malicious payload, malware, or a computer virus. Security alert system 140 may then send an alert to remote cutoff 130, which causes data flow to be immediately interrupted, as described in greater detail below.

In one embodiment of the invention, security alert system 140 may be hosted on an application server or another system server. For example, security alert system 140 may be integrated in a storage manager. Alternatively, security alert system 140 may be hosted on a stand-alone system dedicated to system security.

Security alert system 140 may be coupled to or be integrated in an intrusion detection system, a device or software application that monitors a network for malicious activity or policy violations. Security alert system 140 may receive inputs from multiple sources, including an intrusion detection system or other security information system, an antivirus software package, or even a building security system. Security alert system 140 may use various alarm filtering techniques to distinguish malicious activity from false alarms. In an embodiment of the invention, security alert system 140 may receive input from one or more sniffers 114, which intercept network traffic going to or from a storage device 122 or a storage server 120.

In an embodiment of the invention, security alert system 140 may operate to detect certain emergency situations involving potentially harmful data. Alternatively, or additionally, security alert system 140 may be notified of an emergency situation by another security system such as an intrusion detection system or an antivirus software package. In various embodiments, security alert system 140 may initiate an interruption of data flow into or out of storage device 122 or storage server 120 in response to a request from a system administrator or storage administrator responding to a perceived emergency situation.

In an embodiment of the invention, security alert system 140 may also send a notification to a client computing device 110 which may be affected by the interruption of data flow. In another embodiment, an interruption of data flow is interpreted as packet loss and is handled as such, for example by a storage manager, by standard network data transmission techniques.

Remote cutoff 130 represents an apparatus or software module that may cause data flow through a network switch such as LAN switch 116 or FC switch 112 to be immediately interrupted. In an embodiment of the invention, remote cutoff 130 causes a network cable coupled to the network switch to become disconnected or blocked. In another embodiment, remote cutoff 130 sends a signal to a relay coupled to a network switch that causes the relay to instantly cut off power to the network switch or to block data from entering or exiting the network switch. The relay may be, for example, a solid-state relay or a microprocessor-based relay. In various embodiments of the invention, remote cutoff 130 may be a hardware device controlled by security alert system 140 or a software module included, for example, in security alert system 140 or in one or more storage servers 120.

Fibre Channel (FC) is a high-speed network technology primarily used to connect storage devices such as storage device 122 to storage servers such as storage server 120, and is a core component of most current storage area networks such as SAN 124. An FC switch 112 is a network switch compatible with the FC protocol. A network switch is a computer networking device that connects devices together on a network using packet switching to receive, process, and forward data to destination devices. Although in FIGS. 1 and 2, FC switches 112 are depicted as external to SAN 124, in practice, an FC switch is considered to be one component of the SAN.

LAN switch 116 is a hardware device that connects a computer, for example storage server 120 or client computing device 110, to a network such as network 118. LAN switches typically support either wired Ethernet or various WiFi wireless standards.

Sniffer 114 is a packet sniffer, which may also be known as a network analyzer or network protocol analyzer or, for particular types of networks, an Ethernet sniffer, FC sniffer, or wireless sniffer. In various embodiments of the invention, sniffer 114 may be a software module or hardware device that can intercept packets in a network. For example, sniffer 114 may be a monitoring port in a network switch such as FC switch 112 or LAN switch 116 or a “network tap,” a hardware device that provides access to data in a network. In various embodiments of the invention, sniffer 114 intercepts data that passes over network 118 or SAN 124. Sniffer 114 may transmit the intercepted data to security alert system 140 for analysis or analyze the data and notify security alert system 140 if a potential emergency situation is detected.

FIG. 2 is a schematic diagram depicting an alternative computing environment 200, in accordance with certain embodiments of the present invention. Computing environment 200 includes client computing device 110 connected over SAN 124 via FC switch 112 to storage device 122. Client computing device 110 is also connected to network 118 via an Ethernet connection 126. Security alert system 140 connects to remote cutoff 130, to SAN 124 via an FC connection 128, and to network 118 via an Ethernet connection 126. Remote cutoff 130 is connected to FC switch 112. Computing environment 100 may include one or more client computing devices 110 and one or more storage devices 122. In an embodiment of the invention, computing environment 100 may include a sniffer 114 between storage device 122 and SAN 124, which is connected to security alert system 140.

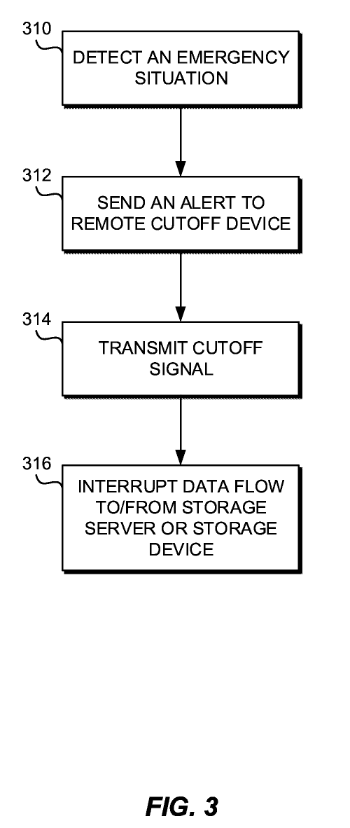

FIG. 3 is a flowchart depicting various operational steps performed by security alert system 140, in accordance with an embodiment of the invention. Security alert system 140 detects or is notified of an emergency situation (step 310) and sends an alert to remote cutoff 130 (step 312). Remote cutoff 130 then transmits a cutoff signal to an appropriate network switch such as LAN switch 116 or FC switch 112 (step 314), which immediately interrupts data flow through the network switch, to or from storage server 120 or storage device 122 (step 316).

The present invention may be a system, a method, and/or a computer program product at any possible technical detail level of integration. The computer program product may include a computer readable storage medium (or media) having computer readable program instructions thereon for causing a computer processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Based on the foregoing, a computer system, method, and computer program product have been disclosed. However, numerous modifications and substitutions can be made without deviating from the scope of the present invention. Therefore, the present invention has been disclosed by way of example and not limitation.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and storage management 96.

The foregoing description of various embodiments of the present invention has been presented for purposes of illustration and description. It is not intended to be exhaustive nor to limit the invention to the precise form disclosed. Many modifications and variations are possible. Such modification and variations that may be apparent to a person skilled in the art of the invention are intended to be included within the scope of the invention as defined by the accompanying claims.

What is claimed is:

1. A computer system comprising:
a network switch coupled to a network;
a remote cutoff device coupled to the network switch; and
a security alert system connected to the network and coupled to the remote cutoff device;
wherein:
the security alert system is operated to receive input from the network indicating data that may be harmful to the computer system and communicate an alert to the remote cutoff device; and
the remote cutoff device is operated to transmit a cutoff signal to the network switch, which causes data flow into or out of the network switch to be immediately interrupted.

2. The computer system of claim 1, further comprising a packet sniffer,
wherein the packet sniffer operates to intercept data passing over the network; and
wherein the packet sniffer further operates to transmit to the security alert system at least one of: the intercepted data and a notification that the intercepted data may be harmful to the system.

3. The computer system of claim 1, wherein the network switch is a Fibre Channel (FC) switch or an Ethernet switch.

4. The computer system of claim 1, wherein the security alert system is a module in a storage management system or an intrusion detection system.

5. The computer system of claim 1, wherein the security alert system is a stand-alone system dedicated to system security.

6. The computer system of claim 1, wherein the security alert system may be further operated to communicate an alert to the remote cutoff device in response to a request by a system administrator or storage administrator.

7. The computer system of claim 1, wherein the security alert system is further operated to receive input from at least one of: an intrusion detection system, a security information system, an antivirus software package, and a building security system.

8. The computer system of claim 1, wherein the data that may be harmful to the system is at least one of: a malicious payload, malware, or a computer virus.

9. A computer system comprising:
a storage server connected to a first network via a first network switch;
the storage server connected to a second network via a second network switch;
a remote cutoff device coupled to the first network switch and the second network switch; and
a security alert system connected to the first network and the second network and coupled to the remote cutoff device;
wherein:
the security alert system is operated to receive input from the first network and the second network indicating data that may be harmful to the computer system and communicate an alert to the remote cutoff device; and
the remote cutoff device is operated to transmit a cutoff signal to at least one of the first network switch and the second network switch, which causes data flow into or out of the storage server to be immediately interrupted.

10. The computer system of claim 9, further comprising a packet sniffer,
wherein the packet sniffer operates to intercept data passing over the first network or over the second network; and
wherein the packet sniffer further operates to transmit to the security alert system at least one of: the intercepted data and a notification that the intercepted data may be harmful to the system.

11. The computer system of claim 9, wherein
the first network switch is a Fibre Channel (FC) switch or an Ethernet switch; and
wherein the second network switch is a Fibre Channel (FC) switch or an Ethernet switch.

12. The computer system of claim 9, wherein the security alert system is a module in a storage management system or an intrusion detection system.

13. The computer system of claim 9, wherein the security alert system is a stand-alone system dedicated to system security.

14. The computer system of claim 9, wherein the security alert system may be further operated to communicate an alert to the remote cutoff device in response to a request by a system administrator or storage administrator.

15. The computer system of claim 9, wherein the security alert system is further operated to receive input from at least one of: an intrusion detection system, a security information system, an antivirus software package, and a building security system.

16. The computer system of claim 9, wherein the data that may be harmful to the system is at least one of: a malicious payload, malware, or a computer virus.

17. The computer system of claim 9, wherein
the first network is a local area network (LAN), a wide area network (WAN), or the internet; and
wherein the second network is a storage area network (SAN).
